(19) United States
(12) Patent Application Publication
(10) Pub. No.: US 2017/0357980 A1
(43) Pub. Date: Dec. 14, 2017

(54) Vehicle Onboard Sensors and Data for Authentication

(71) Applicant: PAYPAL, INC., San Jose, CA (US)

(72) Inventor: Damon Gregory Bakun, San Jose, CA (US)

(21) Appl. No.: 15/179,461

(22) Filed: Jun. 10, 2016

(51) Int. Cl. G06Q 20/40; G06Q 20/32; G06Q 20/10; H04L 29/06

(52) U.S. Cl. CPC G06Q 20/40145; H04L 63/0861; G06Q 20/3224; G06Q 20/102; H04L 63/08

(57) ABSTRACT

Systems and methods that authenticate a user to a vehicle are provided. The authentication system of the vehicle that transports the operator between different locations receives data from a sensor. The data is biometric data, device settings data or portable vehicle instrument storage data. The received data is compared to the data stored in the authentication system. Based on the comparing the use is authenticated to the vehicle and a user profile in the authentication system is identified.

### TECHNICAL FIELD

The disclosure generally relates to authentication and security, and more specifically to using data from sensors of a vehicle to authenticate a user to the vehicle.

### BACKGROUND

A person can conduct an in-person transaction for goods or services using a credit card. In this case, the person authenticates a transaction using a signature and also provides other verification documentation, such as a driver's license with a picture of the person, upon request. When a person conducts a transaction on-line, the on-line system authenticates the person by having the person provide authentication information, such as a username and a password associated with the person's account, and/or by having a person manually enter all or a portion of the credit card information. However, when a person uses a vehicle to transport the person between different locations, the person may not be able to pay with the credit card or provide verification information. For example, the person may not have the credit card or other forms of identity verification, or may not be able to input the information because the person is busy operating the vehicle. As such, what is needed is a way for the person to use the vehicle as an authentication device that conducts a transaction on behalf of the person.

### BRIEF DESCRIPTION OF THE FIGURES

FIGS. 1A-D are diagrams of exemplary systems where embodiments can be implemented.

FIG. 2 is a flowchart of a method for authenticating the person to the vehicle, according to an embodiment.

FIG. 3 is a flowchart of a method for using a vehicle to authenticate the person to a third-party system during a transaction, according to an embodiment.

FIG. 4 is a block diagram of a vehicle authenticating a person to an application, according to an embodiment.

FIG. 5 is a schematic view illustrating an embodiment of a computing system.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The disclosure provides systems, methods, and computer program products for using a vehicle as an authentication device in different transactions. Various sensors associated with the vehicle may detect various data corresponding to a user (e.g., a driver or passenger) in the vehicle. Sensors may be audio sensors, visual sensors, movement sensors, heat sensors, weight sensors, pressure sensors, biometric sensors, etc., that detect different types of data. Data may include biometrics of a user, weight of the user, voice of a user, temperature setting of the vehicle, music selection (e.g., radio station, connection to Bluetooth device, type of music or content, etc.), seat adjustment/location, mirror(s) adjustment/location, position of hands on steering wheel, GPS setting or destination setting on vehicle navigation system, height of user when sitting in vehicle seat (or equivalently distance of user head to vehicle interior roof), driving mode setting (e.g., economy, sport, performance, etc.), and the like. The detected data may then be communicated to an authentication system for analysis and comparison with data consistent with the user. Based on a match, the user may be authenticated as part of transactions conducted in the vehicle. For example, once the user is authenticated, the vehicle can be used to conduct a transaction on behalf of the user with a service provider. The vehicle can also be used to conduct a transaction with a third-party payment provider that receives a transaction from the user on behalf of the service provider. In another example, the vehicle can select between multiple users authenticated by the vehicle when conducting the transaction.

In yet another example, the vehicle can authenticate the user's access to an application. The application can be an insurance selector application or a vehicle statistics tracking application that is associated with the operator of the vehicle and that receives data generated by the vehicle while the vehicle is operated by the user.

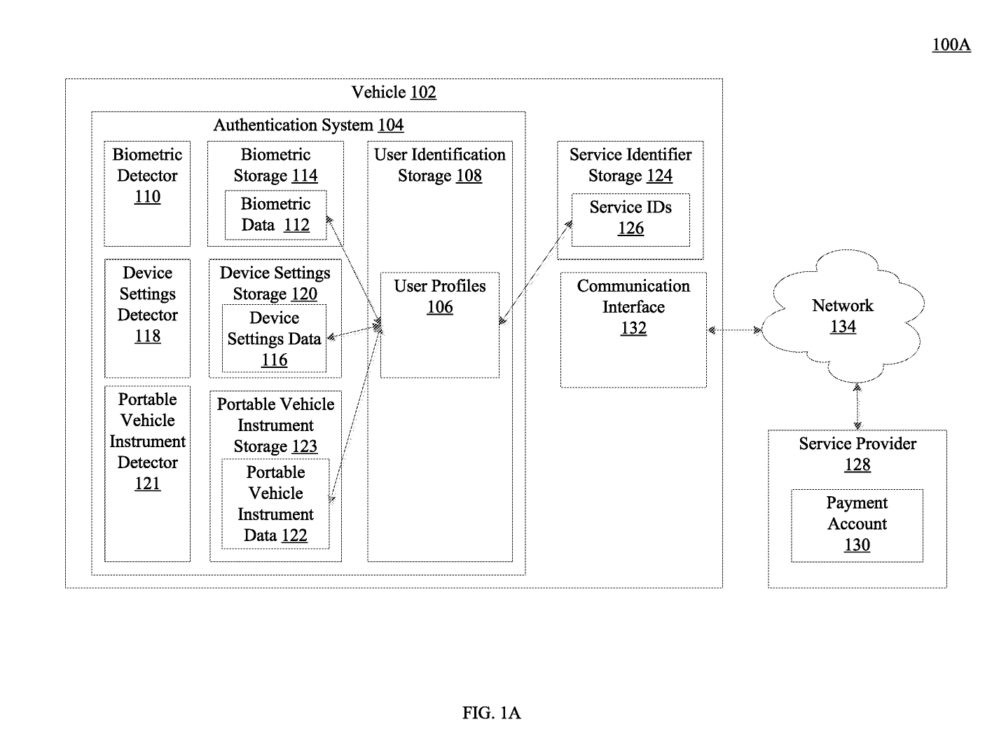

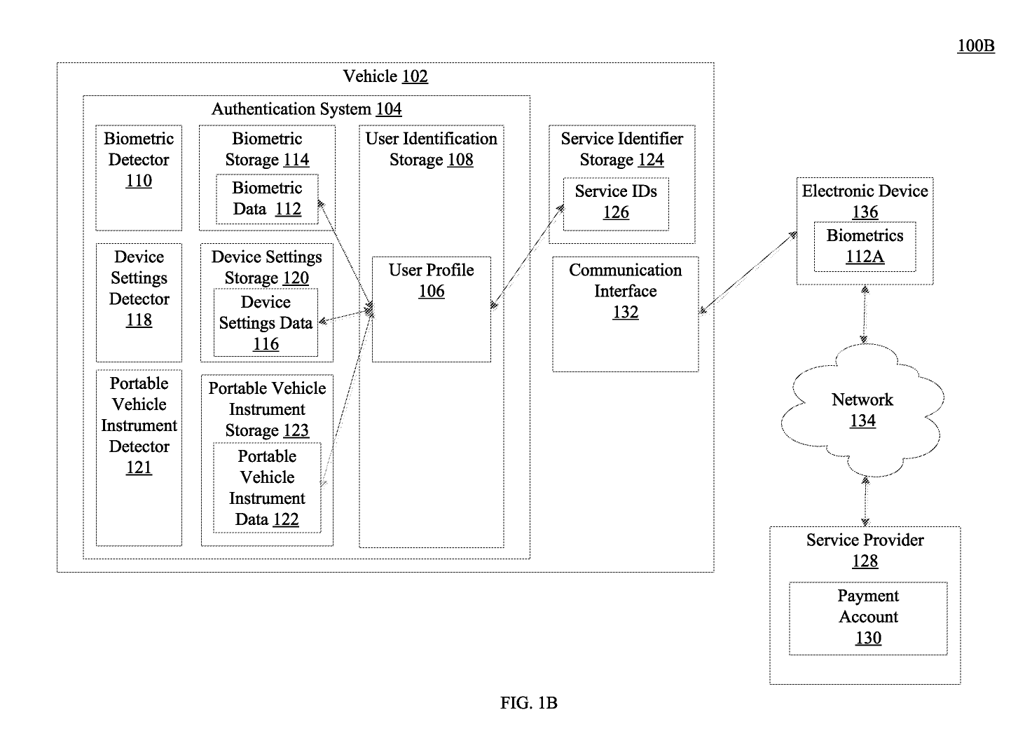

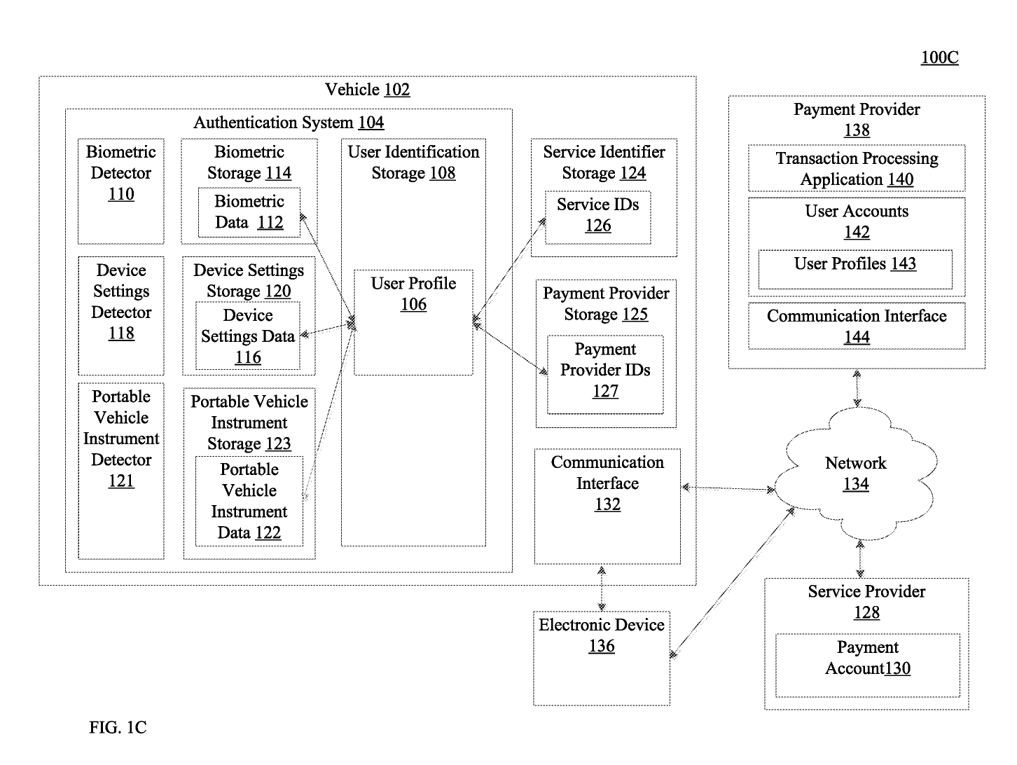

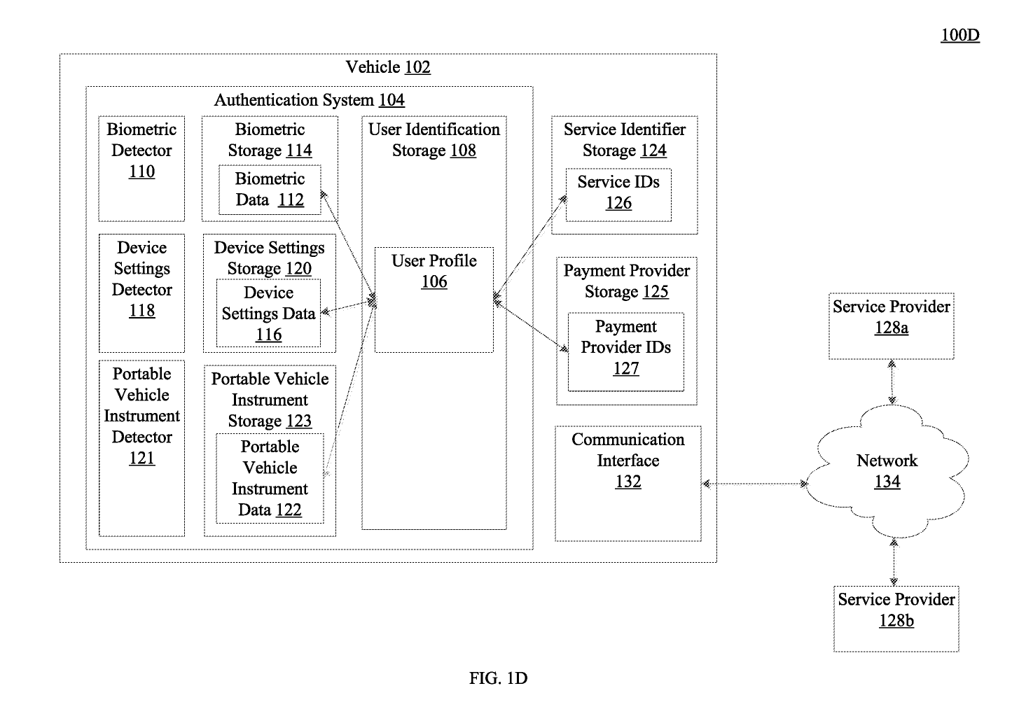

FIG. 1A is an exemplary system 100 where embodiments can be implemented. System 100 includes a vehicle 102. Vehicle 102 may be a transportation vehicle equipped to carry one or more persons between two or more locations. Vehicle 102 may also be controlled by one or more persons. Vehicle 102 may be a motorized vehicle, such as a traditional automobile, motorcycle, scooter, watercraft, hover board, etc. Vehicle 102 may also be a non-motorized transportation device, such as a bicycle, skateboard, rollerblades, ice-skates, etc., that is equipped with one or more computing devices described below.

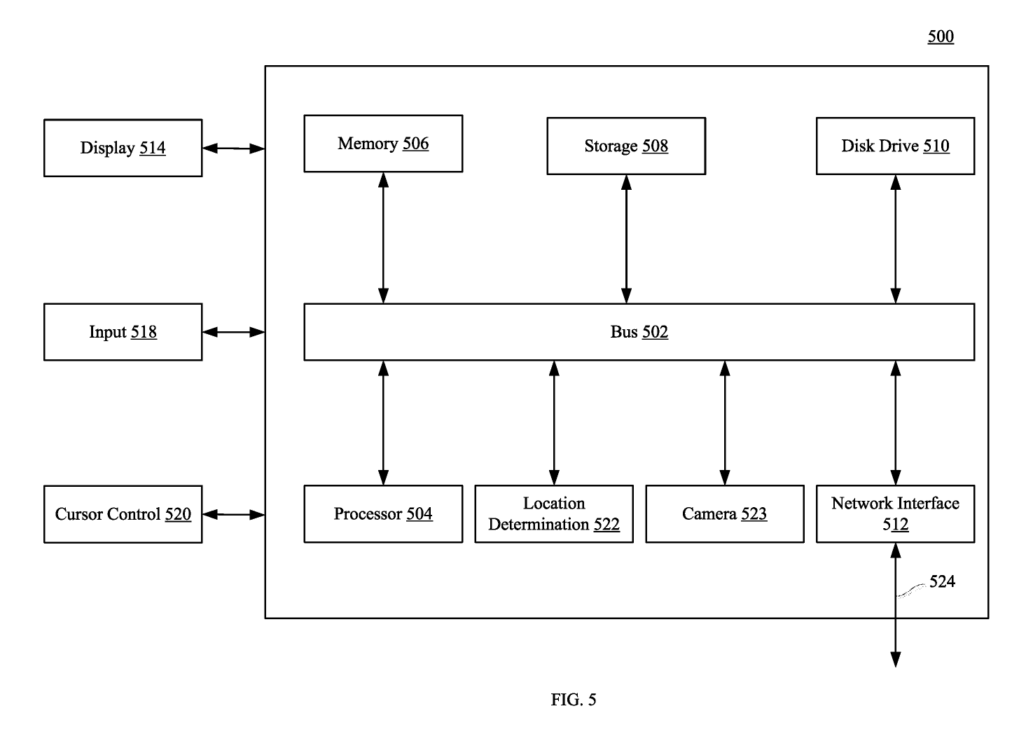

In an embodiment, vehicle 102 may be used to conduct payments on behalf of a person who is operating vehicle 102, is a passenger of vehicle 102 or is in a vicinity of vehicle 102. For example, vehicle 102 may authenticate and conduct payment transactions on behalf of a driver or a passenger of vehicle 102. Vehicle 102 may also differentiate between multiple persons when authenticating and conducting payment transactions. To authenticate and conduct payment transactions, vehicle 102 may be equipped or be coupled to one or more computing components described in FIG. 5.

In an embodiment, vehicle 102 may be equipped with an authentication system 104. The authentication system 104 verifies one or more persons to vehicle 102. To authenticate one or more persons, authentication system 104 includes one or more sensors that detect characteristics of a person or devices that are set to accommodate the person who is inside or within a vicinity of vehicle 102. The sensors sense biometrics of a person, vehicle device settings that are configured to be specific to a person using the vehicle, or one or more portable vehicle instruments that are associated with the person and with the vehicle 102.

In an embodiment, the authentication system 104 authenticates a person to vehicle 102 in a two-step process. The first step is registration, the second step is verification. During the registration process, the authentication system 104 registers or associates a person with vehicle 102 such that the authentication system 104 can verify the identity of the person at a later time, such as during the verification process. As part of the registration process, authentication system 104 creates a user profile 106. User profile 106 is specific to the user and stores authentication information of the user.

In an embodiment, the authentication system 104 may store multiple user profiles 106 in a user identification storage 108. The user identification storage 108 may be one of the storage devices described in detail in FIG. 5.

In an embodiment, the authentication system 104 collects information that identifies the person, such as, one or more biometrics, device settings, etc., and associates the collected information with the user profile 106. To collect the biometrics, the authentication system 104 includes a biometric detector 110. A biometric is a human characteristic that uniquely identifies a person. Example biometrics may include a person's heartbeat, fingerprints, hand geometry, retina and iris patterns, voice patterns, etc. Hence, the biometric detector 110 may include software and hardware components and sensors that determine the person's heartbeat, scan fingerprints and/or hand geometry, perform retina and iris scans, detect voice patterns, etc. These hardware of software components and sensors of biometric detector 110 may be incorporated in different locations throughout vehicle 102. For example, the hardware or software components and sensors may be embedded into a steering wheel, seats, door handles, front panel, display screen, windows, mirrors, wheels, handlebars, etc. In another example, the hardware or software components may be incorporated into a wrist band that is communicatively coupled to vehicle 102.

In one particular example, biometric detector 110 detects a person's heartbeat. Each person has a unique heartbeat, which is a biometric characteristic that does not significantly change with time. To detect the heartbeat, biometric detector 110 may include an electrocardiogram (ECG) sensor that recognizes a unique cardiac rhythm of a person (the ECG).

In an embodiment, biometric detector 110 may collect multiple biometrics of a person. For example, biometric detector 110 may collect a person's heartbeat and fingerprints. The multiple biometrics can, for example, reduce a number of false positives that can occur during the verification process, which is described below.

The ECG and other collected biometrics data of a person are stored as biometric data 112 in biometric storage 114. Biometric storage 114 may be one of the storage devices described in detail in FIG. 5. Additionally, the authentication system 104 also associates biometric data 112 with the user profile 106 of the person in order for the authentication system 104 to verify the person during the verification process. In another implementation, biometric data 112 may also be stored within the user profile 106 (not shown).

In another embodiment, authentication system 104 also collects data for settings of various devices in vehicle 102. Example data may include the seat adjustment/location data, the pressure on a seat from a weight of the user, interior and exterior mirror position, preferred radio station, preferred climate/temperature, music selection (e.g., radio station, connection to Bluetooth device, type of music or content, etc.), position of hands on steering wheel, GPS setting or destination setting on vehicle navigation system, height of user when sitting in vehicle seat (or equivalently distance of user head to vehicle interior roof), driving mode setting (e.g., economy, sport, performance, etc.), or a combination of any of the above. In an embodiment, device settings detector 118 collects or configures the device settings associated with the operator or passenger of vehicle 102. For example, device settings detector 118 may include one or more sensors that record data for settings of different devices in vehicle 102 during the registration process. Example sensors may audio sensors, visual sensors, movement sensors, heat sensors, weight sensors, etc. The device settings detector 118 then associates the collected data for the device settings with the user profile 106 of the person. In an embodiment, the data for the device settings that is associated with the user profile 106 is referred to as device settings data 116. Once collected, the device settings detector 118 stores the device settings data 116 in device settings storage 120. The device settings storage 120 may be one of the storage devices described in detail in FIG. 5. In another implementation, device settings data 116 may also be stored within the user profile 106 (not shown).

In another example, vehicle 102 may include one or more portable vehicle instruments. Example portable vehicle instruments may be a key or a fob of vehicle 102 which is provided by the vehicle manufacturer. The authentication system 104 may also use these portable vehicle instruments to authenticate a person to vehicle 102. A portable vehicle instrument may have an embedded device that emits data, such as a radio frequency identifier (RFID) tag that emits an RFID particular to vehicle 102 and that identifies the portable vehicle instrument to vehicle 102. The authentication system 104 may include a portable vehicle instrument detector 121 that is configured to receive data emitted from the portable vehicle instrument detector 121. Example portable vehicle instrument detector 121 may be a tag reader, such as an RFID tag reader. Once the portable vehicle instrument detector 121 receives the data, authentication system 104 may associate the data from the portable vehicle instrument with the user profile 106. In an embodiment, portable vehicle instrument detector 121 stores the portable vehicle instrument data 122 in a portable vehicle instrument storage 123. The portable vehicle instrument storage 123 may be one of the storage devices described in detail in FIG. 5. In another implementation, portable vehicle instrument data 122 may also be stored within the user profile 106 (not shown).

The examples above that describe the registration process are in no way limiting and other examples for registering a person to vehicle 102 may be used. Further, the authentication system 104 may initiate the registration process on-demand, such as when a person bought or leased vehicle 102, at preconfigured time intervals, upon a request form a manufacturer or a third-party, when an authentication system 104 senses an unregistered operator who uses vehicle 102, etc.

In an embodiment, the second step of the two-step process is the verification process. During the verification process, the authentication system 104 verifies or authenticates the identity of the person using vehicle 102. When a person is verified with vehicle 102, vehicle 102 can be used to conduct payment transactions on behalf of the person.

In an embodiment, the verification process may also be performed using sensors, such as the biometric detector 110, device settings detector 118, portable vehicle instrument detector 121, and the like. For example, biometric detector 110 may scan a biometric of a person. The authentication system 104 then compares the scanned biometric to biometric data 112 stored in biometric storage 114. If the scanned biometric matches to the biometric data 112, the authentication system 104 uses the matched biometric data 112 to identify the person and the associated user profile 106. In yet another embodiment, the biometric detector 110 may scan a second biometric and determine whether the second biometric matches the biometric data 112 that is associated with the user profile 106. If the biometric data 112 is verified, the authentication system 104 authenticates the person to vehicle 102.

In another example, the authentication system 104 may use the device setting detector 118 to authenticate a person to vehicle 102. Here, the device settings detector 118 may detect data for one or more device settings in vehicle 102 upon a person entering, activating, or using vehicle 102. The authentication system 104 then compares the detected data of one or more device settings with the device settings data 116 stored in the devices settings storage 120. If the data of the one or more detected device setting matches to the device settings data 116, the authentication system 104 identifies the user profile 106 that is associated with device settings data 116, and verifies the person to vehicle 102.

In yet another example, the authentication system 104 may use the portable vehicle instrument to authenticate the person to vehicle 102. Here, the portable vehicle instrument detector 121 detects data transmitted by the portable vehicle instrument in the vicinity of vehicle 102. The portable vehicle instrument detector 121 receives the data and compares the received data to the portable vehicle instrument data 122 associated with user profile 106. If there is a match, the authentication system 104 authenticates the person to vehicle 102.

In an embodiment, authentication system 104 may perform the verification process using one or more sensors, that sense biometrics, determine device settings and/or receive data from portable device instrument(s). Authentication system 104 may use a combination of the one or more sensors to authenticate a person. In a further embodiment, the authentication system 104 performs the verification process at predefined intervals, daily, upon a person entering or using vehicle 102, or on-demand.

As discussed above, vehicle 102 may be used to authenticate and conduct payments transactions. Typically, these payment transactions belong to the operator or passenger of the vehicle verified by the authentication system 104. To conduct payments transactions, vehicle 102 is associated with service providers 128. Service providers 128 provide goods or services to one or more persons in exchange for payment using one or more computing systems, collectively referred to as server provider server(s). The service provider servers can process payment transactions from multiple persons, and can include components described in FIG. 5. Example service providers 128 may be a carwash, a gas station, a drive through grocery store, a coffee shop, etc.

In an embodiment, a person registers with one or more service providers 128 and receives a service ID 126. The service ID 126 may be unique to a registered person, and may have a numeric, alphanumeric, or another type of a value. A person can use the service ID to conduct transactions with the service provider 128. Because a person can register with numerous service providers 128, the person can be associated with multiple service IDs 126. Alternatively, a person can be assigned a service ID 126 by a third party and provide the service ID 126 for registration to multiple service providers 128.

In an embodiment, the service providers 128 or the person may provide service ID 126 to vehicle 102. The service ID 126 may be provided during the registration process between a person and vehicle 102, during the registration process between the person and the service provider 128, or at another time. Also, the service ID 126 may be downloaded to vehicle 102 wirelessly or through another memory device such as a memory stick, a compact disk, etc.

Once the service ID is downloaded to vehicle 102, the service ID 126 is associated with the user profile 106 and is stored in the service identifier storage 124. In another embodiment, service ID 126 may be stored with the user profile 106 (not shown). The service identifier storage 124 may be one of the storage devices described in detail in FIG. 5.

In a further embodiment, the service ID 126 may be included in a tag, such as a RFID tag. In this case, the tag may be provided and stored in vehicle 102 (not shown) and may also associated with the user profile 106 of the person registered with vehicle 102.

In an embodiment, the service provider 128 may use the service ID 126 to perform payment transactions for goods or services. For example, the service provider 128 may have a payment account 130 associated with the person and with service ID 126. The payment account 130 may have been previously established by the person at the service provider 128. When the service provider 128 receives the service ID 126 from vehicle 102, the service provider 128 associates the service ID 126 with the payment account 130 and deducts the payment for the service from the payment account 130. In a further embodiment, along with a service ID 126, vehicle 102 also provides the payment amount to the service provider 128 to be subtracted from the payment account 130 or to be entered into the payment account 130 to be billed to the person at a later time.

In an embodiment, vehicle 102 also includes a communication interface 132. The communication interface 132 allows vehicle 102 to exchange data with, for example, service provider 128 over network 134. Example data may be service ID 126 and the payment amount. Network 134 may be any number of wired and/or wireless networks such as a Local Area Network (LAN), a Wide Area Network (WAN), a Metropolitan Area Network (MAN), the Internet, or the like that can carry and transmit data.

In another embodiment, where service ID 126 is included in a tag, such as an RFID tag, the service provider 128 may read information from the tag outside of network 134. For example, the service provider 128 may be equipped with the tag reader that may energize the tag stored in vehicle 102 and cause the tag to transmit the service ID 126 using designated radio frequency waves (not shown), in one embodiment. In another embodiment, the RFID tag may broadcast the service ID 126 at request of vehicle 102.

Once the service ID 126 is stored in vehicle 102, the vehicle 102 may conduct payment transactions for goods or services from service providers 128 on behalf of a person authenticated by the authentication system 104 of vehicle 102. For example, the authentication system 104 may first verify the person, such as an operator of vehicle 102, using one or more sensors. The verification may be biometric verification, using, for example the person's heartbeat. The authentication system 104 verifies the heartbeat using biometric data 112 stored in the biometric storage 114. Once the person is verified, the vehicle 102 can access the user profile 106 of the person, obtain the service ID 126 corresponding to the service provider 128. Vehicle 102 can then use service ID 126 to authenticate and conduct payment transactions for goods and services provided by service providers 128. In an embodiment, vehicle 102 conducts payment transactions without further action from the verified person.

In one example, the verified operator of vehicle 102 arrives at a carwash station, which is a type of the service provider 128. If the operator is associated with the service ID 126 for the carwash station, vehicle 102 can provide the service ID 126 to the carwash station to conduct a payment transaction without additional input from the operator. The carwash station can use the service ID 126 to identify and access the payment account 130 associated with the operator and subtract the payment amount for washing the car, or alternatively add the payment amount to the payment account 130 of the operator, for a deferred payment.

In another example, the verified operator of vehicle 102 arrives at a gas station where the operator has payment account 130. A gas station is a type of a service provider 128. If the service ID 126 for the gas station is stored in the service identifier storage 124, vehicle 102 can provide the service ID 126 to the gas station to conduct the payment transaction without additional input from the operator. The gas station then uses the service ID 124 to identify and access payment account 130 of the operator, and subtract the payment amount for the purchase of gas from payment account 130.

In another example, when event vehicle 102 is driven by an operator that was not verified by the authentication system 104, such as a thief who stole vehicle 102 or a child who took a parent's or friend's vehicle 102 for a joy ride, the unverified operator will not be able to make payments at service providers 128 (such as at a carwash station or a gas station), even if the vehicle 102 stores the corresponding service IDs 126. For example, when authentication system 104 cannot verify the operator of the vehicle 102 according to the methods described above, the vehicle 102 cannot access the service IDs 126 of the service providers 128, and cannot transmit the service IDs 126 to the service providers 128 to initiate payment for transactions.

In an embodiment, vehicle 102 may not be able to connect to network 134 and establish a connection with the service provider 128. In this case, vehicle 102 may use an electronic device of an operator or another person to connect to service provider 128. FIG. 1B is a block diagram 100B of a system where a vehicle conducts payment transaction using an electronic device, according to an embodiment. As illustrated in FIG. 1B, communication interface 132 of vehicle 102 cannot connect to network 134. However, communication interface 132 can establish a local connection to an electronic device 136. The connection between communication interface 132 and electronic device 136 may be a wired or wireless connection, such as a universal serial bus (USB) cable connection or a wireless Bluetooth® connection. Example electronic device 136 may be an Internet enabled mobile communication device, a portable computing device, a laptop, a tablet, a game console, or the like, which has hardware and software to establish a connection with network 134.

In an embodiment, once communication interface 132 establishes a connection with electronic device 136, the communication interface 132 transmits the service ID 126 to service provider 128 by way of electronic device 136. In this way, vehicle 102 uses electronic device 136 to conduct a payment transaction with service provider 128.

In an embodiment, electronic device 136 may also store biometric information associated with the user, such as biometric data 112A. Electronic device 136 may receive biometric data 112A from the user during the user's configuration with electronic device 136. Biometric data 112A may be stored in the electronic device 136 or in another device that connects to the electronic device 136 over network 134 (not shown) in order to authenticate the user to the electronic device 136.

In an embodiment, authentication system 104 may obtain biometric data 112A from the electronic device 136 and store biometric data 112A as part of biometric data 112. For example, vehicle 102 may connect to the electronic device 136 using communication interface 132. The user of electronic device 136 may then request for the electronic device 136 to download biometric data 112A to vehicle 102 and to associate the biometric data 112A with the user profile 106 and use biometric data 112A to conduct transactions as described above. Electronic device 136 may also be similarly use to download other types of data used to authenticate a person to vehicle 102.

In another embodiment, vehicle 102 may authenticate a verified operator to a third-party, such as a third-party payment provider. A payment provider accepts payments for transactions from a user, such as a vehicle operator on behalf of service provider 128. FIG. 1C is a block diagram 100C of a system where a vehicle conducts a payment transaction with a payment provider, according to an embodiment. The payment provider 138 may include a payment provider server maintained, for example, by a payment provider, which may provide user account and payment services to a person who is associated with user profile 106 stored in vehicle 102. In this regard, payment provider 138 includes one or more processing applications, which may provide payment for items using a user account associated with that payment provider 138. In one example, payment provider 138 may be systems provided by PAYPAL®, Inc. of San Jose, Calif., USA. Other payment providers 138 may also include systems associated with merchants, financial services providers, credit card providers, banks, and/or other payment providers, which may provide user account services and/or payment services to different users, such as a verified person associated with vehicle 102.

Each payment provider 138 may include a transaction processing application 140, user accounts 142 and user profiles 143, and a communication interface 144. Transaction processing application 140 may correspond to processes, procedures, and/or applications executable components described in FIG. 5.

Payment provider 138 also includes user accounts 142. User accounts 142 may be established with payment provider 138 by various people, including an operator of vehicle 102. User accounts 142 may be stored in a database or another computing system of the payment provider 138, such as a computing system discussed in FIG. 5. User accounts 142 may include or be associated with user profiles 143. User profile 143 may store information, including user credentials, such as, name, address, and birthdate, payment/funding information, travel information, additional user financial information, and/or other desired user data associated with a user of the user account 142. User profile 143 may also store authentication information associated with the user of one of the user accounts 142. Example authentication information may include user biometrics that may have been uploaded into the user account over network 134, username/password authentication information, etc.

User accounts 142 may also be associated with a payment provider IDs 127. Payment provider ID 127 is an identifier that vehicle 102 may use to identify a corresponding user account 142. Payment provider ID 127 may be downloaded to vehicle 102 using communication interfaces 144 and 132, provided to vehicle 102 via electronic device 136, or provided to vehicle 102 via a thumb drive, a disk, or another storage device by or upon a request of a user associated with user account 142 and user profile 106. Once payment provider ID 127 is provided to vehicle 102, authentication system 104 associates the payment provider ID 127 with one of user profiles 106 and stores the payment provider ID 127 in payment provider storage 125. The payment provider storage 125 may be one of the memories described in FIG. 5.

Payment provider 138 may also provide authentication information to the authentication system 104, according to an embodiment. For example, once payment provider ID 127 is associated with the user profile 106, payment provider 138 can download authentication information, such as, biometric data to the authentication system 104 to be stored as biometric data 112. For instance, during the registration process, payment provider 138 may download the authentication information, such as biometrics stored in the user profile 143 to be stored in biometric storage 114.

In an embodiment, authentication information stored in the user profile 143 may be supplemented with the authentication information from the authentication system 104. For example, a user may use electronic device 136 to authenticate the user to one of the user accounts 142 using biometric or username-PIN/password authentication and use sensors on vehicle 102 to authenticate to the authentication system 104. The payment provider 138 can then use transaction processing application 140 to request some or all biometric data 112, device settings data 116, portable vehicle instrument data 122, etc., associated with user profile 106 to be uploaded to user profile 143 associated with user account 142 of the payment provider 138. Further, the authentication information in user profile 143 may be continuously updated based on the sensor data that is stored in authentication system 104 each time a user authenticates or re-registers with the authentication system 104.

In an embodiment, transaction processing application 140 may be configured to receive information from one or more vehicles 102 and/or service providers 128 for processing and completion of the payment transactions. For example, once authentication system 104 verifies an operator as described above, vehicle 102 may transmit data that includes payment provider ID 127 associated with a verified operator that identifies a user account 142 in payment provider's 138 system, authentication information, user credentials and transaction data. Transaction data may include a service ID 126 of service provider 128 that requests payment and the payment amount. Further vehicle 102 may transmit data to payment provider 138 without further input from the verified operator.

The transaction processing application 140 may receive data from vehicle 102. Transaction processing application 140 may use the payment provider ID 127 to identify user account 142 associated with the verified user of vehicle 102. From the user account 142 transaction processing application 140 may also determine the user profile 143. Transaction processing application 104 may compare authentication information in the user profile 143 to the authentication information and user credentials transmitted from vehicle 102. Once authenticated, transaction processing system may use the transaction data received from vehicle 102 to conduct a payment transaction on behalf of service provider(s) 128. For example, transaction processing application 140 may use the service ID 126 included in the transaction data to identify the service provider 128. Transaction processing application 140 may also use the user profile 143 to determine whether the payment provider 138 is authorized to make the payment transaction for the amount specified in the transaction data. If so, payment provider 138 conducts a transaction on behalf of vehicle 102 with service provider 128. In various embodiments, transaction processing application 140 may provide transaction histories, including receipts, to a verified operator of vehicle 102 in order to provide proof of purchase for a good and/or service.

In another embodiment, the authentication information received from vehicle 102 also includes biometric data 112, device settings data 116, etc. In this case, transaction processing application 140 may identify user account 142 associated with the user of vehicle 102 by comparing data including biometric data 112, device settings data 116 etc., to the authentication information stored in the user profile 143. When transaction processing application 140 matches biometric data 112 or device settings data 116 data to the authentication information stored in user profile 143, transaction processing application 140 may complete the payment transaction for the purchase of goods or services provided by the service provider 128.

As discussed above, each payment provider 138 may include at least one communication interface 144. The communication interface 144 is adapted to connect to network 134 and communicate with vehicle 102, electronic device 136, and service provider 138 over network 134.

In yet another embodiment, vehicle 102 can be used to conduct transactions for multiple persons. FIG. 1D is a block diagram of a system 100D, where a vehicle conducts payment transactions on behalf of multiple persons, according to an embodiment. For example, authentication system 104 may verify multiple persons that are present or in the vicinity of vehicle 102. The first person may be sitting in a driver seat and is verified using biometric detector 110 located on a steering wheel and a second person may be sitting in a passenger seat and is verified using a combination of the portable vehicle instrument data 122 and device settings data 116. In one instance, a person sitting in a driver seat may be associated with user profile 106a and a person sitting in a passenger seat may be associated with a user profile 106b. Further, the user profile 106a may be associated with service IDs 126a and 126b of service providers 128a and 128b, while user profile 106b may be associated with service ID 126c of service provider 126b.

In an embodiment, vehicle 102 may conduct payment transactions associated with service provider 128a or 128b. For example, vehicle 102 may conduct payment transactions at service provider 128a using service ID 126a which is associated with the driver. In another example, when both the driver and the passenger are associated with service IDs of the same service provider, such as service provider 128b, vehicle 102 may determine whether to conduct the payment transaction using service ID 126a which is associated with the driver or the service ID 126c which is associated with the passenger. The determination may be made based on different criteria, such as the location of a person in vehicle 102. For example, the service ID associated with a driver may have precedence over a service ID associated with a passenger. In this case, vehicle 102 will conduct the payment transaction using service ID 126b. The determination may also be based on a predetermined order that is associated with user profile 106a or 106b and which may be configured during the registration process described above. In yet another embodiment, an authorized person may also manually select which service ID (service ID 126b or 126c) vehicle 102 should use to conduct the transaction. Once vehicle 102 determined which service ID to use for the transaction, vehicle 102 conducts the payment transaction using the determined service ID.

In an embodiment, user profile 106a and 106b may also be associated with different payment provider IDs (not shown). In this case, vehicle 102 may also select a payment provider ID associated with user profile 106a or 106b to conduct a transaction using payment provider 138 according to embodiments described above.

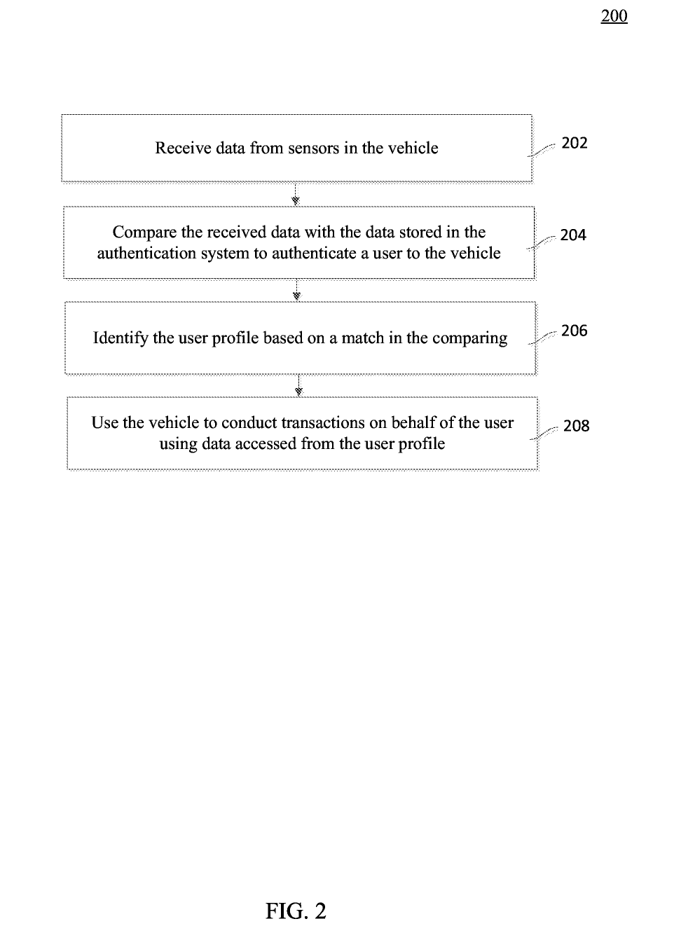

FIG. 2 is a flowchart of a method 200 for authenticating the person to the vehicle, according to an embodiment. Method 200 may be implemented using hardware and software components described in FIGS. 1A-D.

At operation 202, data from the data sensors is received. For example, authentication system 104 receives biometric data, device settings data, or portable vehicle instrument data associated with one or more users that entered, activated, or began using vehicle 102. In one instance, authentication system 104 receives data from biometric detector 110 that measures the person's heartbeat, scans fingerprint(s), scans hand geometry, scans retina or iris, analyzes voice patterns, etc., or a combination of the above. In another instance, device settings detector 118 senses one or more device settings associated with the person, and provides the authentication system 104 with the data associated with the device settings. In another example, portable vehicle instrument detector 121 receives data that identifies the portable vehicle instrument.

At operation 204, the data is compared to the data stored in the authentication system to authenticate the user. For example, authentication system 104 compares the biometric data, device settings data or data associated with the portable vehicle instrument received in operation 202 to biometric data 112, device settings data 116 and/or portable vehicle instrument data 122. If authentication system 104 identifies a match between the data received in operation 202 and the data stored in the authentication system, the user is authenticated and the flowchart proceeds to operation 206. Otherwise, the flowchart ends.

At operation 206, a user profile is identified based on the comparing. For example, if the data received in operation 202 matches the biometric data 112, device settings data 116 and/or portable vehicle instrument data 122, or a combination thereof, the authentication system 104 retrieves the user profile 106 associated with the biometric data 112, device settings data 116 and/or portable vehicle instrument data 122. Once vehicle 102 has access to the user profile 106 of the user which includes service IDs 126 and/or payment provider IDs 127. Vehicle 102 can use service IDs 126 and/or payment provider IDs 127 to conduct transactions at service provider 128 and payment provider 138 on behalf of the authenticated user without further input from the user. In another embodiment, operation 204 and operation 206 may be switched, such that after sensor data is received (which may include a vehicle identifier), a user profile may be retrieved from an account of the user associated with the sensor data or vehicle identifier. The user profile or profiles (where the vehicle identifier may have accounts associated not just the vehicle owner, but also passengers who have been in the vehicle previously) are then compared to the received sensor data for authenticating the user.

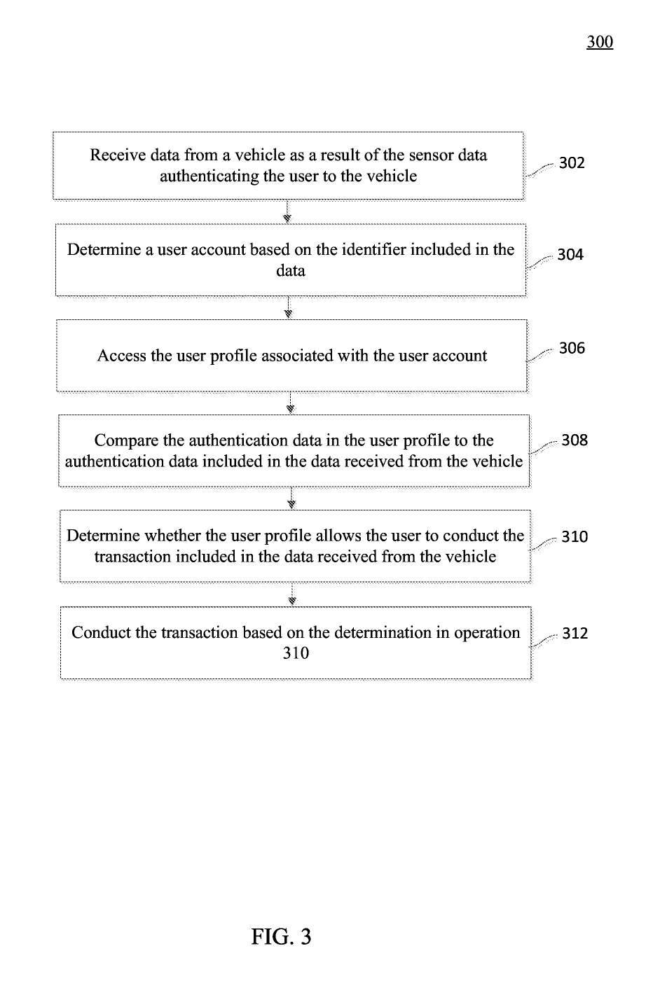

At operation 208, a vehicle is used to conduct a transaction. For example, vehicle 102 may arrive at a location of a service provider 128, such as a carwash station, a gas station, or a coffee shop. The verified person may request goods or services for a particular amount. In response, vehicle 102 transmits data that includes the service ID 126 associated with the person to the service provider 128. Once the service provider 128 receives the service ID 126, the service provider 128 uses the service ID 126 to identify the person and the payment account 130. The service provider 128 then subtracts the payment amount from the money deposited in the payment account 130. As described above, the payment amount may be set by the service provider 128 or be included in data transmitted from vehicle 102. Alternatively, service provider 128 may post the payment amount to the payment account 130 and bill the person for the payment amount at a later time. In another example, vehicle 102 may conduct a payment transaction for a particular amount with the payment provider 138 on behalf of service provider 128. For example, vehicle 102 conducts the payment transaction by transmitting data that includes payment provider ID 127 of the verified operator, authentication data, user credentials, and transaction data that includes a service ID 126 and amount to payment provider 138. Once payment provider 138 receives the data, the payment provider 138 makes a payment to service provider 128 on behalf of the verified operator as described above and further in FIG. 3 and flowchart 300. Note that different actions can be performed with different devices after the user is authenticated through vehicle sensor data. For example, once authenticated, the user's mobile device may be notified of the user authentication (e.g., through the vehicle or a service provider), such that the user may then perform transactions through the mobile device without further authentication. In other words, the user may be able to perform transactions through the mobile device without having to enter biometric or other authentication information, such as a password or PIN. This results in a more user-friendly and time-saving experience.

FIG. 3 is a flowchart of a method 300 for using a vehicle to authenticate the person to a third-party system during a transaction, according to an embodiment. Method 300 may be implemented using hardware and software components described in FIGS. 1A-D.

At operation 302, data from a vehicle is received at a payment provider. For example, once the authentication system 104 receives the sensor data and authenticates an operator or passenger to vehicle 102, vehicle 102 transmits data to the payment provider 128. The data may include an identifier, such as payment provider ID 127 that is associated with the user authenticated by the authentication system 104 of vehicle 102, authentication information, user credentials, transaction information, or any combination thereof. The communication interface 144 of payment provider 138 receives the data and passes the data to the transaction processing application 140.

At operation 304, a user account associated with an identifier in the data is determined. For example, transaction processing application 140 identifies payment provider ID 127 in the data received in operation 302 and associated the payment provider ID 127 with user account 142.

At operation 306, the user profile is accessed. For example, transaction processing application 140 accesses the user profile 143 associated with the user account 142.

At operation 308, the data transmitted in operation 302 is compared to the data in the user profile. For example, transaction processing application 140 compares the data in the user profile 143 to the authentication information transmitted as part of data in operation 302. The transmitted authentication information may be biometric data 112, device settings data 116, etc., which is stored in authentication system 104. The comparison may authenticate the verified user of vehicle 102 to the payment provider 138. If the transaction processing application 140 authenticates the user, method 300 proceeds to operation 310. Otherwise, the method ends.

At operation 310, a determination whether a transaction can be conducted is made. For example, transaction processing application 140 retrieves transaction data from the data received in operation 302. The transaction data includes service ID 126 and a transaction amount. Transaction processing application 140 may use the transaction data to determine whether the user associated with the user profile 143 has authority to conduct a transaction for the amount and with a service provider 128 associated with the service ID 126. If the transaction cannot be conducted, method 300 ends. Otherwise, the method proceeds to operation 312.

At operation 312, transaction is conducted. For example, based on the determination in operation 310, the payment provider 138 conducts the transaction on behalf of the user authenticated using vehicle 102 with service provider 128.

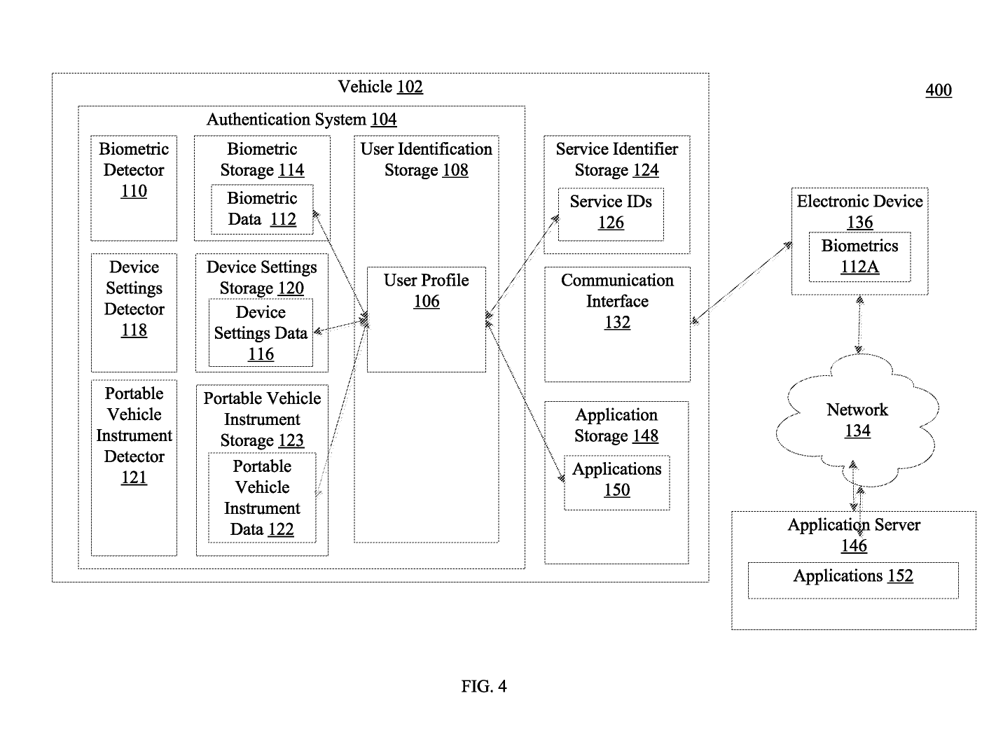

In an embodiment, vehicle 102 may also authenticate a person to different applications. The applications may execute on vehicle 102 or on a remote server, or both, and may use data generated by vehicle 102. FIG. 4 is a block diagram 400 of a vehicle authenticating a person to an application, according to an embodiment. As illustrated in FIG. 4, vehicle 102 may also include an application storage 148. The application storage 148 may be one of the memories discussed in FIG. 5. In an embodiment, the application storage 148 stores one or more applications 150. Application 150 executes on vehicle 102 and receives and processes data generated by vehicle 102. Example data may include speed data, data pertaining to the driving patterns, location data, distance data, fuel/electricity utilization data, data associated with the cost of operating the vehicle on daily, weekly, monthly, and yearly basis, etc. Example application 150 may be an insurance selector application and vehicle statistics tracking application, though the implementation is not limited to these embodiments. An insurance selector application may monitor vehicle data and then recommend an insurance and insurance premium to a person operating vehicle 102 based on the data. Further, the insurance and the insurance premium may vary from month to month based on the projected usage of vehicle 102 or the person's driving habits. Further, the person may also use vehicle 102 to pay the insurance premium according to the methods discussed above. A vehicle statistics tracking application may track and aggregate data pertaining to the person's utilization of vehicle 102.

In an embodiment, applications 150 may be web or cloud applications. In this regard, applications 150 may also include components located on application server 146. The application server 146 may be a cloud server, storage server, web server, or another type of server that is accessible over network 134, and that can receive, process, aggregate, etc., data provided by applications 150. In an embodiment, the counterparts to applications 150 that are located on application server 146 are referred to as applications 152. Typically, applications 152 store multiple user accounts and corresponding data for users that that utilizing applications 150 executing on vehicles 102. In another embodiment, applications 150 may also be downloaded to vehicle 102 from the application server 146.

In an embodiment, applications 150 may upload data to the applications 152 based on the connectivity of vehicle 102 to network 134. For example, when vehicle 102 can access network 134 on-demand, communication interface 132 may upload and download the data between applications 150 and applications 152 upon request from applications 150 or 152. On the other hand, when vehicle 102 is Wi-Fi enabled, the communication interface 132 may upload and download data between applications 150 and applications 152 when communication interface 132 establishes Wi-Fi connectivity with network 134, such as when vehicle 102 is parked at a Wi-Fi enabled home of the operator.

In an embodiment, vehicle 102 may use the authentication system 104 to verify a person and enable vehicle 102 to access one or more applications 150 on behalf of the verified person. For example, during the registration process, vehicle 102 may link a user account of a person that is associated with application 150 to user profile 106 stored on vehicle 102. In this way, when a authentication system 104 verifies the person to vehicle 102 as described above, vehicle 102 can access the user account associated with application 150 and allow application 150 to execute and/or collect data from vehicle 102. In an embodiment, application 150 alone, or in combination with application 152 collects and processes data that is specific to the verified person associated with vehicle 102.

For instance, in case of an insurance selector application, suppose two operators are interchangeably using vehicle 102. When vehicle 102 verifies a first operator, using for example, the first operator's heartbeat, the insurance selector application collects the data pertaining to the first operator's driving habits as the first operator drives vehicle 102. When, the second operator replaces the first operator, and vehicle 102 verifies the second operator using, for example, the device settings data 116. Once the second user is authenticated, the insurance selector application collects the data pertaining to the driving habits of the second operator. The insurance selector application may then upload the data from the first and second operators to the application server 146, where the server counterpart to the insurance selector application generates an insurance policy and insurance premium for the first operator and also for the second operator. In a further embodiment, the application server 146 may transmit the insurance policy and insurance premium for the first operator and/or the second operator to vehicle 102 or to the respective electronic devices 136 associated with the first operator and/or the second operator. In yet a further embodiment, vehicle 102 can pay for the insurance policy according to the methods described above.

In an embodiment, a third operator may also drive vehicle 102. However, the authentication system 104 cannot verify the third operator according to the methods described above. In this case, vehicle 102 does not authenticate the third operator to the insurance selector application, and the insurance selector application cannot obtain data from vehicle 102 that is associated with the third operator.

In another instance, in case of a vehicle statistics tracking application, suppose two operators are interchangeably using vehicle 102. When vehicle 102 verifies a first operator, using for example, the first operator's heartbeat, the vehicle statistics tracking application collects data pertaining to the first operator's utilization of vehicle 102. When, the second operator replaces the first operator, and vehicle 102 verifies the second operator using, for example, the device settings data 116 and portable vehicle instrument data 122, the vehicle statistics tracking application collects the data pertaining to second operator's utilization of vehicle 102. The vehicle statistics tracking application may then upload the data from the first and second operators to the application server 146, where the server counterpart to the vehicle statistics tracking generates vehicle utilization statistics for the first operator and the second operator. In a further embodiment, the application server 146 may transmit the vehicle utilization statistics for the first operator and/or the second operator to vehicle 102 or the respective electronic devices 136 associated with the first operator and/or second operator. In another embodiment, the vehicle statistics tracking application may generate and display the vehicle utilization statistics using the computing system of vehicle 102.

Referring now to FIG. 5 an embodiment of a computer system 500 suitable for implementing, the systems and methods described in FIGS. 1A-D and 2-4 is illustrated.

In accordance with various embodiments of the disclosure, computer system 500, such as a computer and/or a server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 518 (e.g., keyboard, keypad, or virtual keyboard), a cursor control component 520 (e.g., mouse, pointer, or trackball), a location determination component 522 (e.g., a Global Positioning System (GPS) device as illustrated, a cell tower triangulation device, and/or a variety of other location determination devices known in the art), and/or a camera component 523. In one implementation, the disk drive component 510 may comprise a database having one or more disk drive components.

In accordance with embodiments of the disclosure, the computer system 500 performs specific operations by the processor 504 executing one or more sequences of instructions contained in the memory component 506, such as described herein with respect to the mobile communications devices, mobile devices, and/or servers. Such instructions may be read into the system memory component 506 from another computer readable medium, such as the static storage component 508 or the disk drive component 510. In other embodiments, hard-wired circuitry may be used in place of or in combination with software instructions to implement the disclosure.

Logic may be encoded in a computer readable medium, which may refer to any medium that participates in providing instructions to the processor 504 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 510, volatile media includes dynamic memory, such as the system memory component 506, and transmission media includes coaxial cables, copper wire, and fiber optics, including wires that comprise the bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 500. In various other embodiments of the disclosure, a plurality of the computer systems 500 coupled by a communication link 524 to the network 134 (e.g., such as a LAN, WLAN, PTSN, and/or various other wired or wireless networks, including telecommunications, mobile, and cellular phone networks) may perform instruction sequences to practice the disclosure in coordination with one another.

The computer system 500 may transmit and receive messages, data, information and instructions, including one or more programs (i.e., application code) through the communication link 524 and the network interface component 512. The network interface component 512 may include an antenna, either separate or integrated, to enable transmission and reception via the communication link 524. Received program code may be executed by processor 504 as received and/or stored in disk drive component 510 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A system, comprising:
a non-transitory memory storing instructions; and
one or more hardware processors coupled to the non-transitory memory and configured to read the instructions from the non-transitory memory to cause the system to perform operations comprising:
receiving data from a sensor in a vehicle equipped to transport a user between different locations, wherein the data is associated with the user of the vehicle;
comparing the data from the sensor with data stored in an authorization system for the vehicle to verify the user to the vehicle;
identifying a profile of the user based on the comparing; and
using the vehicle to conduct a transaction with a third party server on behalf of the user, wherein data used to conduct the transaction includes data that is accessed from the profile.

2. The system of claim 1, wherein the sensor is a biometric sensor and the data from the sensor is biometric data.

3. The system of claim 2, wherein the biometric data pertains to a heartbeat of the user.

4. The system of claim 1, wherein the data received from the sensor is device settings data that includes settings of a device included in the vehicle set specifically for the user.

5. The system of claim 1, wherein the data received from the sensor is a portable vehicle instrument data generated by a portable vehicle instrument of the vehicle configured for the user.

6. The system of claim 1, wherein the transaction is a payment transaction to a service provider server.

7. The system of claim 1, wherein the transaction is a payment transaction to a payment provider server that provides payment to a service provider on behalf of the user.

8. The system of claim 1, wherein the operations further comprise:
receiving second data from a sensor in the vehicle, wherein the second data is associated with the second user of the vehicle;
comparing the second data to the data stored in the authorization system of the vehicle to verify the second user to the vehicle;
identifying the second user profile of the second user based on the comparing;
determining whether to conduct the transaction on behalf of the user or the second user based on a location of the first user and the second user in the vehicle; and
based on the determination, using the vehicle to conduct the transaction on behalf of the user or the second user.

10. A system, comprising:
a non-transitory memory storing instructions; and
one or more hardware processors coupled to the non-transitory memory and configured to read the instructions from the non-transitory memory to cause the system to perform operations comprising:
receiving, from a vehicle equipped to transport a user between multiple locations, vehicle sensor data associated with a user in the vehicle, wherein the vehicle sensor data includes an identifier that identifies the vehicle to the payment provider server;
determining a user account from the identifier;
accessing a user profile associated with the user account;
comparing the vehicle sensor data to vehicle authentication data in the user profile;
authenticating, based on the comparing, the user; and
processing a transaction for the user based on the authenticating.

11. The system of claim 10, wherein the vehicle sensor data includes biometric data.

12. The system of claim 11, wherein the biometric data includes data pertaining to a heartbeat of the user.

13. The system of claim 10, wherein the vehicle sensor data includes device settings data of a device configured specifically for the user.

14. The system of claim 10, wherein the comparing comprises:
obtaining from the vehicle sensor data, a first type of vehicle sensor data and a second type of vehicle sensor data;
comparing the first type of the vehicle sensor data to the vehicle authentication data; and
comparing the second type of the vehicle sensor data to the vehicle authentication data.

15. The system of claim 10, wherein the operations further comprise:
communicating the authenticating to a mobile device associated with the user.

16. The system of claim 10, wherein the operations further comprise:
updating the vehicle authentication data based on the authenticating.

17. A method, comprising:
receiving data from a vehicle as a result of sensor data detecting a user in the vehicle, wherein the data includes an identifier that identifies the vehicle to the payment provider server;
determining a user account from the identifier, wherein the user account is associated with the user;
accessing a user profile associated with the user account;
matching the data to vehicle authentication data in the user profile, wherein the user profile includes transaction information; and
based on matching, conducting a transaction between a first server and a second server using the transaction information.

18. The system of claim 10, wherein the data received from the vehicle comprises physical or physiological measurements of the user.

19. The system of claim 10, wherein the data received from the vehicle includes device settings data.

20. The system of claim 10, wherein the matching comprises:
obtaining from the data, a first type of data and a second type of data;
comparing the first type of data to the vehicle authentication data in the user profile; and
comparing the second type of data to the vehicle authentication data in the user profile.
